(19) United States
(12) Patent Application Publication
(10) Pub. No.: US 2023/0081902 A1
(43) Pub. Date: Mar. 16, 2023

(54) IMAGE FORMATION APPARATUS AND METHOD FOR CONTROLLING IMAGE FORMATION APPARATUS

(71) Applicant: KONICA MINOLTA, INC., Tokyo (JP)

(72) Inventor: Shoichi NOMURA, Tokyo (JP)

(73) Assignee: KONICA MINOLTA, INC., Tokyo (JP)

(21) Appl. No.: 17/818,167

(22) Filed: Aug. 8, 2022

(30) Foreign Application Priority Data
Sep. 14, 2021 (JP) 2021-149402

(51) Int. Cl. G03G 15/23; G03G 15/00

(52) U.S. Cl. CPC G03G 15/234; G03G 15/5062; G03G 2215/047; G03G 2215/00721; G03G 2215/00734; G03G 2215/00759

(57) ABSTRACT

An image formation apparatus includes: an image former that prints an image on paper; a corrector that corrects a print position of the image on the paper; and a first sensor that is disposed on a conveyance path upstream of the image former, detects paper, and outputs detection data to the corrector, wherein the corrector obtains, on the basis of the detection data, an amount of change in a shape of first paper from a shape of second paper printed before the first paper is printed, and corrects a print position of a first image on the first paper on the basis of the change amount.

The entire disclosure of Japanese patent Application No. 2021-149402, filed on Sep. 14, 2021, is incorporated herein by reference in its entirety.

### BACKGROUND

### Technological Field

The present disclosure relates to an image formation apparatus, and more specifically, to a technique for correcting an image to be printed.

### Description of the Related Art

When performing two-sided printing, an image formation apparatus performs front-side printing on paper, reverses the paper in a reverse path, performs back-side printing on the reversed paper, and then ejects the paper. When two-sided printing is continually performed, if a size of the paper changes, positions of images printed on front and back sides of the paper are deviated accordingly. Therefore, in order to deal with this problem, there has been appeared an image formation apparatus or the like in which an image sensor that reads an image printed on paper is disposed on a paper ejection path, and an image to be printed is corrected according to a change in size of the paper.

Regarding a technique for correcting an image to be printed, for example, JP 2014-238544 A discloses an image formation apparatus that “includes an image transfer unit, fixing unit, and inversion unit, and can transfer images onto the front and rear faces of a sheet. The image formation apparatus performs the correction of an image in which the time from when a size measuring unit measures the size of a sheet to when the sheet reaches a transfer position is on the basis of the measured size of the sheet, and the size measuring unit is arranged on a conveyance path so that the above-described time becomes equal to or longer than the time required for a transfer belt having the corrected image transferred thereon to reach the transfer position. The correction of an image is performed on at least one of the front and rear faces of the sheet.” (refer to [Abstract]).

Other techniques for correcting an image to be printed are disclosed in, for example, JP 2009-42461 A, JP 2010-212745 A, and JP 2017-209935 A.

According to the techniques disclosed in JP 2014-238544 A, JP 2009-42461 A, JP 2010-212745 A, and JP 2017-209935 A, it is possible to correct image position deviation when a size of printing paper changes, while it is necessary to correctly measure the size of the printing paper for correct control of an image position. Thus, implementation method therefor has been a problem. Therefore, in a case where a shape of the paper has changed rapidly during printing, the image to be printed cannot be corrected, or even if the image is corrected, the correction may be delayed because the correction is performed after observation of a print result. Therefore, there is a need for a technique for immediately correcting an image to be printed even when there is a change in shape of paper during printing.

### SUMMARY

The present disclosure has been made in view of the above background, and an object in one aspect is to provide a technique for immediately correcting an image to be printed even if a shape of paper is changed during printing.

To achieve the abovementioned object, according to an aspect of the present invention, an image formation apparatus reflecting one aspect of the present invention comprises: an image former that prints an image on paper; a corrector that corrects a print position of the image on the paper; and a first sensor that is disposed on a conveyance path upstream of the image former, detects paper, and outputs detection data to the corrector, wherein the corrector obtains, on the basis of the detection data, an amount of change in a shape of first paper from a shape of second paper printed before the first paper is printed, and corrects a print position of a first image on the first paper on the basis of the change amount.

### BRIEF DESCRIPTION OF THE DRAWINGS

The foregoing and other objects, advantages, aspects, and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example of a hardware configuration of an image formation system 100 according to an embodiment;

FIG. 2 is a diagram showing an example of a configuration of a main control circuit of the image formation system 100 according to an embodiment;

FIG. 3 is a diagram showing an example of a first stage of a procedure for correcting an image to be printed on paper;

FIG. 4 is a diagram showing an example of a second stage of the procedure for correcting an image to be printed on paper;

FIG. 5 is a diagram showing an example of a third stage of the procedure for correcting an image to be printed on paper;

FIG. 6 is a diagram showing an example of a fourth stage of the procedure for correcting an image to be printed on paper;

FIG. 7 is a diagram showing an example of timing of each processing in the image formation system 100;

FIG. 8 is a flowchart showing a first example of internal processing in the image formation system 100;

FIG. 9 is a flowchart showing a second example of internal processing in the image formation system 100;

FIG. 10 is a diagram showing a second example of a hardware configuration of an image formation system according to an embodiment;

FIG. 11 is a diagram showing a third example of a hardware configuration of the image formation system according to an embodiment;

FIG. 12 is a diagram showing an example of a result of correcting an image position deviation amount when the processing shown in the flowchart in FIG. 9 is executed;

FIG. 13 is a diagram showing a first application example of image correction by the image formation system according to an embodiment; and

FIG. 14 is a diagram showing a second application example of image correction by the image formation system according to an embodiment.

### DETAILED DESCRIPTION OF EMBODIMENTS

Hereinafter, one or more embodiments of the technical idea according to the present invention will be described with reference to the drawings. In the following description, the same components are denoted by the same reference numerals. Their names and functions are also the same. Therefore, detailed descriptions thereof will not be repeated. However, the scope of the invention is not limited to the disclosed embodiments.

### A. Configuration of Image Formation System

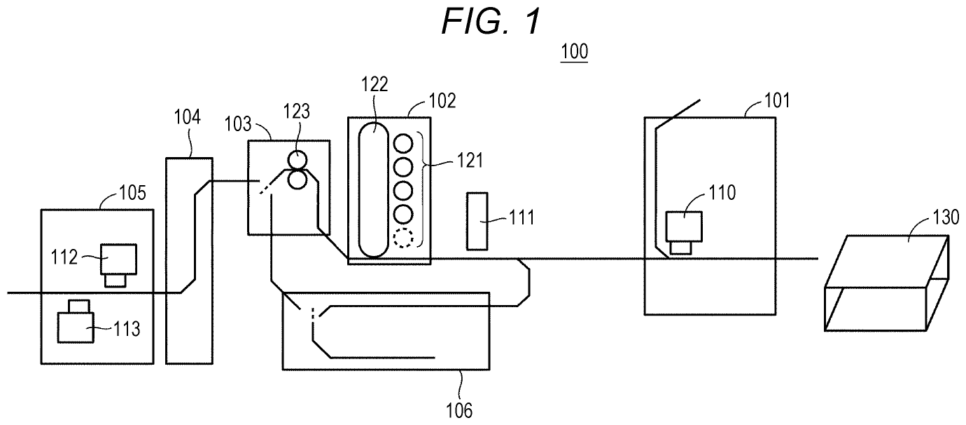

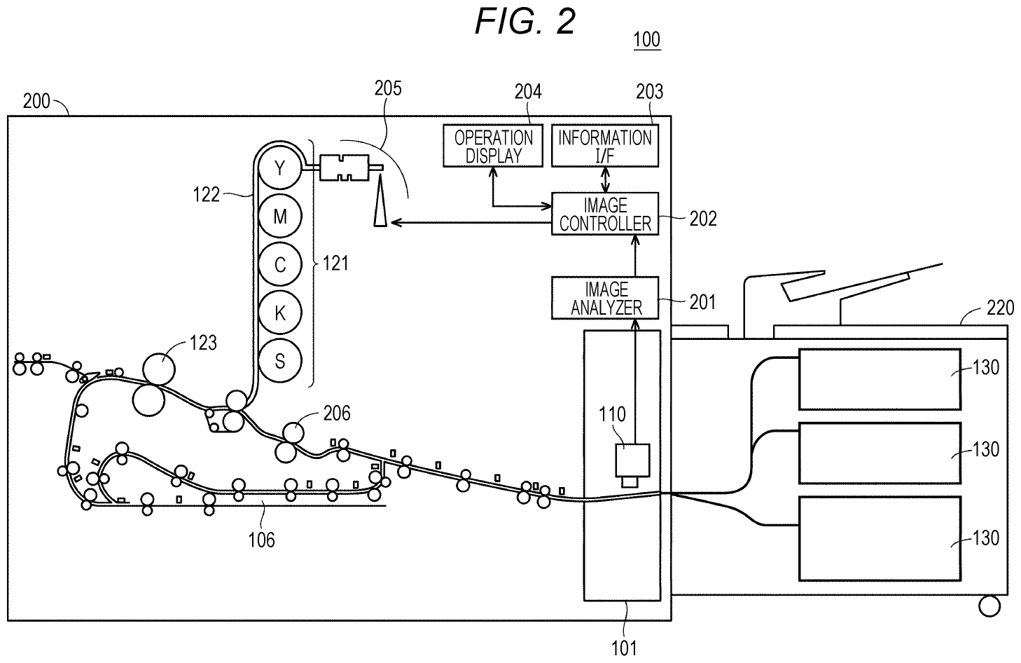

First, an example of overview of a hardware configuration and operation of an image formation system according to the present embodiment will be described with reference to FIGS. 1 and 2. In one aspect, the image formation system according to the present embodiment may include an arbitrary configuration other than the configurations shown in FIGS. 1 and 2. In another aspect, the image formation system according to the present embodiment may not include a part of the configurations shown in FIGS. 1 and 2.

FIG. 1 is a diagram showing an example of a hardware configuration of an image formation system 100 according to the present embodiment.

The image formation system 100 mainly includes a first medium sensing unit 101, a paper pass sensor 111, an image transferer 102, a fixer 103, a relay unit 104, a second medium sensing unit 105, a paper reverser 106, and a paper feed tray 130.

The first medium sensing unit 101 includes a medium sensor 110. The second medium sensing unit 105 includes medium sensors 112 and 113. The image transferer 102 includes a photoreceptor unit 121 of each color and an intermediate transfer belt 122. The fixer 103 includes a fixing roller 123. The image transferer 102 and the fixer 103 may be collectively referred to as an image former.

By using the medium sensor 110, the first medium sensing unit 101 senses paper conveyed from the paper feed tray 130. The medium sensor 110 is, for example, an image sensor. As an example, an image analyzer 201 (refer to FIG. 2) may detect a shape of the paper, a type of the paper, or both by analyzing an image acquired from the medium sensor 110. Here, the shape of the paper may include a size, angle, distortion, and the like of the paper in vertical and horizontal directions.

The paper pass sensor 111 may be disposed, for example, near a registration roller 206 (refer to FIG. 2). The paper pass sensor 111 detects the conveyed paper. As an example, on the basis of a signal acquired from the paper pass sensor 111, the image analyzer 201 may detect that a leading edge of the paper comes into contact with the registration roller 206.

The image transferer 102 transfers an image input as a print job onto the paper via the photoreceptor unit 121 and the intermediate transfer belt 122. The photoreceptor unit 121 may include, for example, a photoreceptor unit that forms toner images of each of cyan, magenta, yellow, black (key plate), and a special color. The toner image formed on the photoreceptor unit 121 of each color is transferred to the intermediate transfer belt 122, and the respective transferred toner images form a final color (including black and white) toner image. The toner image transferred to the intermediate transfer belt 122 is transferred to the conveyed paper.

The fixer 103 heats the conveyed paper by the fixing roller 123 including a heater to fix the toner image on the paper. In a case of one-sided printing, the paper having had a front side thereof subjected to the fixing processing is conveyed to the relay unit 104. In a case of two-sided printing, the paper having had the front side thereof subjected to the fixing processing is conveyed to the paper reverser 106, and the paper having had a back side thereof subjected to the fixing processing is conveyed to the relay unit 104.

The paper reverser 106 reverses the paper and returns the reversed paper to a conveyance path upstream of the registration roller 206. An image is printed on the back side of the paper reversed by the paper reverser 106 with a procedure the same as the procedure with which the image is printed on the front side.

The relay unit 104 conveys the paper for which print processing has been completed toward a paper ejection tray.

Via the medium sensors 112 and 113, the second medium sensing unit 105 acquires the image printed on the paper. The medium sensors 112 and 113 are, for example, image sensors. As an example, the image analyzer 201 may detect deviation of the image printed on the paper by analyzing the image acquired from the medium sensors 112 and 113. The image deviation here may include, for example, deviation between a position of an image printed on a front side of first paper and a position of the image printed on a front side of second paper. The image deviation may also include, for example, deviation between a position of an image printed on a front side of certain paper and a position of the image printed on a back side thereof.

FIG. 2 is a diagram showing an example of a configuration of a main control circuit of the image formation system 100 according to the present embodiment. As an example, the image formation system 100 includes an image formation apparatus 200 and a paper tray apparatus 220. In one aspect, the image formation system 100 may be implemented as one image formation apparatus including the image formation apparatus 200 and the paper tray apparatus 220.

The image formation apparatus 200 includes, as main control circuits, the image analyzer 201, an image controller 202, an information interface (I/F) 203, an operation display 204, and an image formation controller 205.

The image analyzer 201 acquires an image (image detection data) from the first medium sensing unit 101, a signal from the paper pass sensor 111, and an image (image detection data) from the second medium sensing unit 105. Note that there may be one image analyzer as shown in the drawing, and the first medium sensing unit 101, the second medium sensing unit 105, there is an image analyzer for each to receive and analyze each image separately and, mutually, or there is a third image analyzer separately from them. There may be a configuration in which an analysis result of each is received from the each image analyzer, and various control of image position correction is performed.

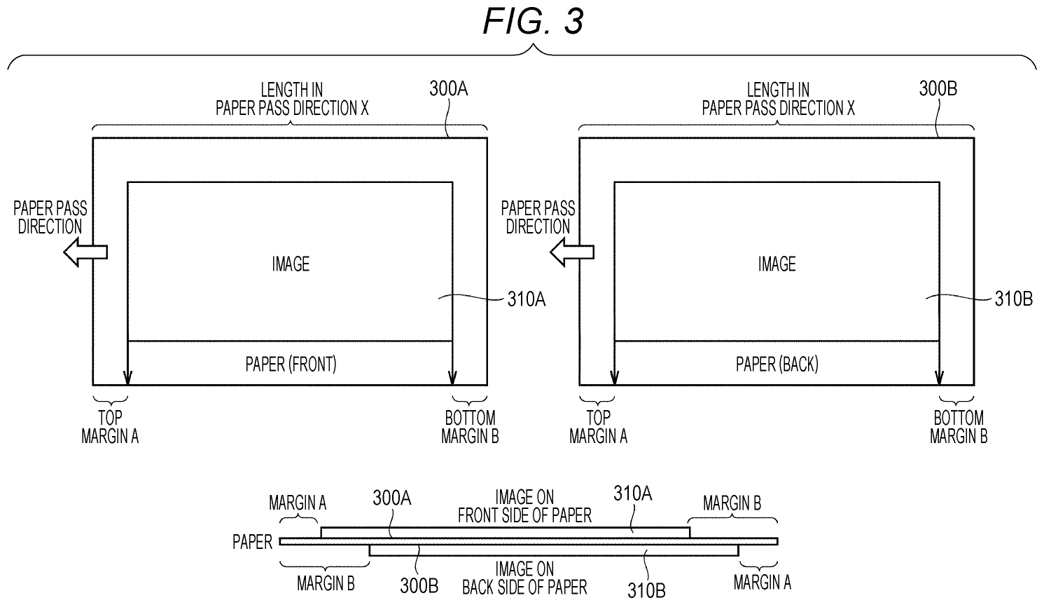

In addition, the image analyzer 201 analyzes these images and signals, detects a change in shape of the paper, and corrects an image to be printed on the paper on the basis of the change in the shape of the paper. The image correction may include, for example, adjustment of a print position of the image, deformation of the image, or the like. An example of the image correction will be described later with reference to FIGS. 3 to 6, 13, and 14. The image analyzer 201 outputs an image correction amount to the image controller 202. The image analyzer 201 corrects an image, and therefore can also be referred to as an image corrector. In one aspect, the image analyzer 201 may acquire, from the image controller 202, information of a print job or the like, for example. In this case, the image analyzer 201 may generate the image correction amount on the basis of the information of the print job (print image), and a part or all of the image from the first medium sensing unit 101, a signal from the paper pass sensor 111, and the image from the second medium sensing unit 105.

The image controller 202 executes the input job. The job may include, for example, processing of printing an image on paper, processing of saving the image as data, and the like. In a case of acquiring the image correction amount, the image controller 202 outputs a print command of the corrected image to the image formation controller 205.

The information I/F 203 is an interface for communication with an external device. The information I/F 203 may receive a job from the external device and output the job to the image controller 202. In one aspect, a wired local area network (LAN) port may be used as the information I/F 203. In another aspect, a Wi-Fi (registered trademark) module may be used as the information I/F 203. The information I/F 203 may transmit and receive data by using a communication protocol such as Transmission Control Protocol/Internet Protocol (TCP/IP) or User Datagram Protocol (UDP).

The operation display 204 presents information to a user and receives input operation by the user. The input operation may include, for example, setting of printing. In one aspect, the operation display 204 may be an operation panel including a display, an operation button, and the like. In this case, the display may include a liquid crystal monitor, an organic electro luminescence (EL) monitor, and the like. The liquid crystal monitor, the organic EL monitor, and the like may include a touch sensor, display an operation menu, and receive an input by the touch by the user.

The image formation controller 205 controls the image transferer 102 on the basis of the print command acquired from the image controller 202. In one aspect, the image formation controller 205 may also control the fixer 103. In another aspect, a function of the image formation controller 205 may be included in the image controller 202.

### B. Correction of Printed Image

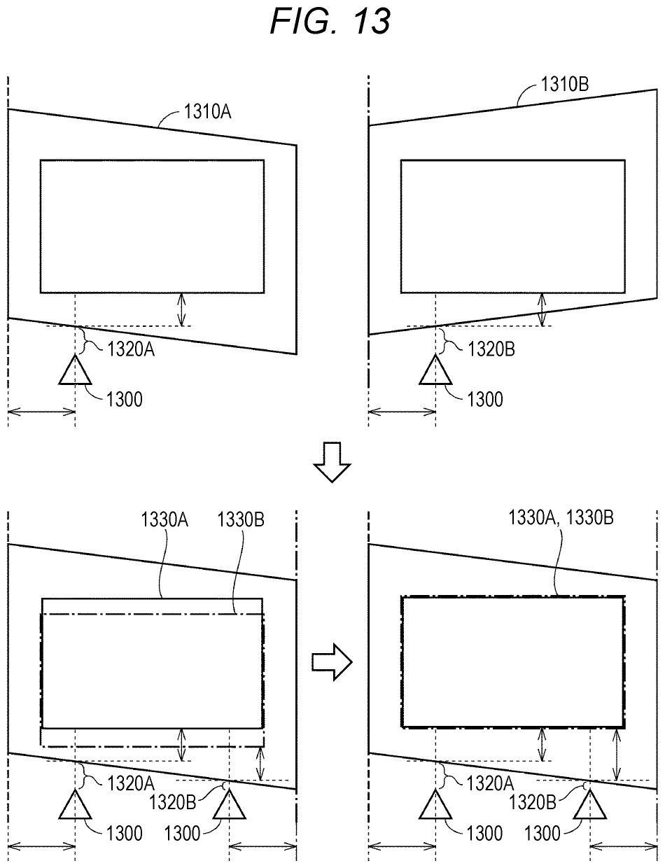

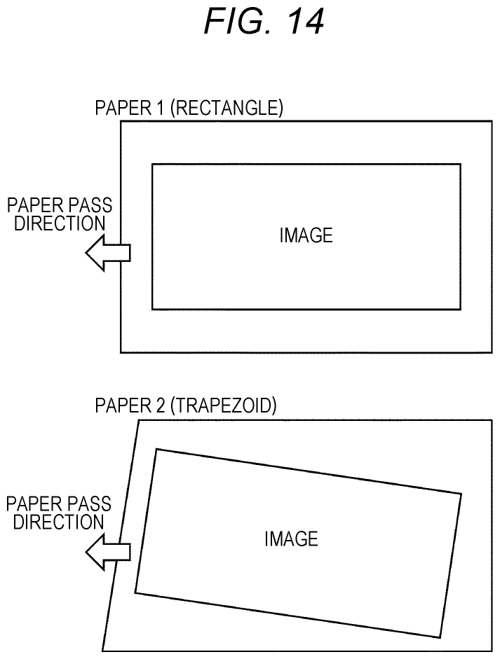

Next, with reference to FIGS. 3 to 6, how the image to be printed on the paper is corrected in a case where the shape (length in a paper pass direction) of the paper changes will be described (correction in a case where the shape of the paper is distorted or the like will be described later with reference to FIGS. 13 and 14). In addition, the image formation system 100 may operate differently for each length of the conveyed paper in the paper pass direction. The operation of the image formation system 100 will also be described.

(a. Procedure for Correcting Image)

FIG. 3 is a diagram showing an example of a first stage of a procedure for correcting the image to be printed on the paper. First, the image analyzer 201 detects, on the basis of the image (image on paper) acquired from the first medium sensing unit 101, a paper length serving as a reference length, and sets the length of the paper in the paper pass direction as, for example, a reference length “X mm”. Next, the image controller 202 performs two-sided printing on the paper. It is assumed that an image 310A is printed on a front side 300A of the paper, and an image 310B is printed on a back side 300B of the paper.

Sheets of the paper may be created by the user cutting a roll of paper, and, therefore, may be not in the same length. For example, even if the image formation apparatus 200 recognizes sizes of the conveyed sheets of paper as the A4 size, there may be a slight difference in length among the sheets of the paper in the paper pass direction. In this case, margins of sheets next to each other are inconsistent. In the example shown in FIG. 3, a top margin of the front side 300A of the paper in the paper pass direction is “A mm”, a bottom margin thereof is “B mm”. Therefore, lengths of the margins are different. In this case, if the image formation apparatus 200 performs two-sided printing on the paper, print positions of the image on the front side 300A and back side 300B of the paper are deviated from each other, because directions of the image are different between the front side 300A and back side 300B of the paper.

The image analyzer 201 stores a reference length “X mm” (length in the paper pass direction), top margin “A mm”, and bottom margin “B mm” of the paper. In one aspect, the image analyzer 201 may include a storage (not shown) for storing the reference length “X mm”, top margin “A mm”, and bottom margin “B mm” of the paper, or may utilize a storage at another location.

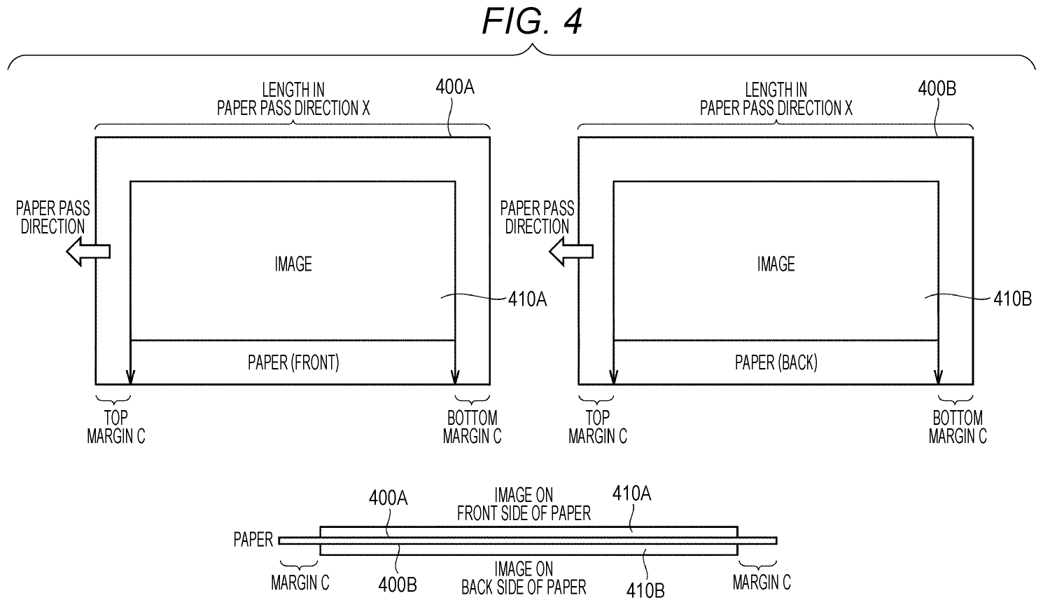

FIG. 4 is a diagram showing an example of a second stage of the procedure for correcting the image to be printed on the paper. In a case where a sheet of paper having a length in the paper pass direction the same as the reference length “X mm” is detected on the basis of the image acquired from the first medium sensing unit 101 after the processing described with reference to FIG. 3 is executed, the image analyzer 201 corrects the image so that the positions of the images to be printed on both sides of the paper coincide with each other.

More specifically, the image analyzer 201 generates, on the basis of the reference length “X mm”, the top margin “A mm”, and the bottom margin “B mm” (or on the basis of the amount of the image position deviations between the front and back sides), a correction amount (correction amount of print setting) such that the top margin and bottom margin of the paper in the paper pass direction are the same, and outputs the correction amount to the image controller 202.

In the example shown in FIG. 4, the image analyzer 201 generates the correction amount such that the top margin and bottom margin of an image 410A to be printed on a front side 400A of the paper are “C mm”. In this case, the top margin and bottom margin are equal. Therefore, if the image formation apparatus 200 performs two-sided printing on the paper, a position of the image 410A printed on the front side 400A of the paper and a position of an image 410B printed on a back side 400B of the paper coincide with each other. As described above, in a case where a sheet of paper having a length in the paper pass direction the same as the reference length “X mm” is detected, the image formation system 100 may correct image position deviation by correcting the image as described above.

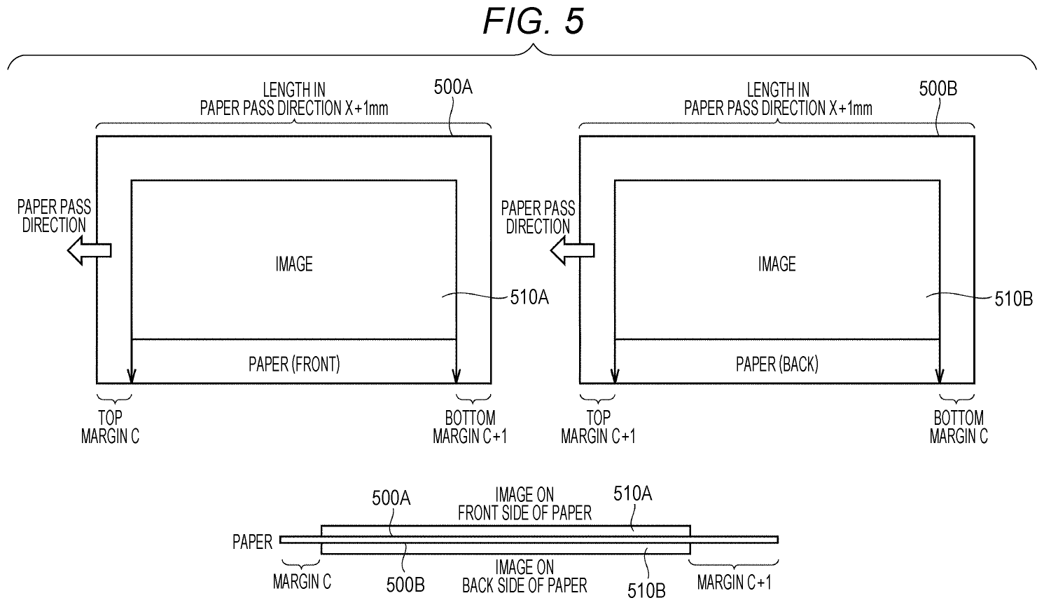

FIG. 5 is a diagram showing an example of a third stage of the procedure for correcting the image to be printed on the paper. Next, image correction in a case where the image formation apparatus 200 prints an image on a sheet of paper having a length different from the reference length “X mm” will be described.

In a case where a sheet of paper having a length in the paper pass direction, the length being not the reference length “X mm”, is detected (in a case where an amount of change in shape of the paper is detected) on the basis of the image acquired from the first medium sensing unit 101 after the processing described with reference to FIG. 3 is executed, the image analyzer 201 generates a correction amount so that the top margin of an image 510A on a front side 500A of the paper is always constant (for example, “C mm”). Next, when printing an image 510B on a back side 500B of the paper, the image analyzer 201 generates the correction amount so that a bottom margin of the image 510B on the back side 500B of the paper always coincides with a top margin of the image 510A on the front side 500A of the paper (in this case, “C mm”). In this way, the image formation system 100 can always keep one margin of the paper constant. In the example shown in FIG. 5, the image formation system 100 can always keep the one margin of the paper at “C mm”.

In one aspect, the image analyzer 201 may generate the correction amount such that the bottom margin of the image 510A on the front side 500A of the paper is always constant. In this case, the image analyzer 201 generates the correction amount so that the top margin of the image 510B on the back side 500B of the paper always coincides with the bottom margin of the image 510A on the front side 500A of the paper.

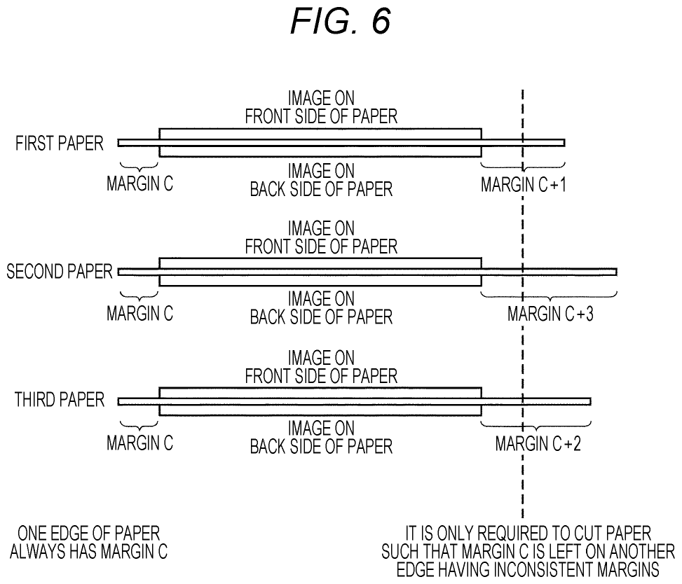

FIG. 6 is a diagram showing an example of a fourth stage of the procedure for correcting the image to be printed on the paper. As described with reference to FIGS. 3 to 5, in a case where printing is performed on sheets of paper having different lengths, the image formation system 100 prints an image on the paper so that the margin on one side of the paper always has the length “C mm” calculated on the basis of the reference length “X mm” of the paper. As a result, by cutting the sheets of the paper such that all the margins (inconsistent margins) on one edge of the sheets will be “C mm” after the paper is cut, the user can easily unify the shape of the paper, and have the print position of the image at a center of the paper.

(b. Overview of Operation by Image Formation Apparatus for Each Paper)

As described with reference to FIGS. 3 to 6, the image formation system 100 may execute printing of an image while always keeping one margin of paper constant. The image formation system 100 uses a first operation procedure or second operation procedure to be described below in order to always keep one margin of the paper constant even when the shape (length in the paper pass direction) of the paper has changed rapidly.

First, the first operation procedure will be described with reference to FIG. 2. When a sheet of short paper is sensed, the image formation system 100 executes the first operation procedure. Here, the short paper means paper of which a leading edge thereof does not come into contact with the registration roller 206 from when the leading edge of the paper passes through the medium sensor 110 to when a trailing edge thereof passes through the medium sensor 110. In other words, the short paper is paper of which length in the paper pass direction is shorter than the conveyance path between the medium sensor 110 and the registration roller 206.

In a case where the short paper is conveyed from the paper feed tray 130, the image analyzer 201 senses the shape (length in the paper pass direction) of the image before the print processing on the basis of a change in the image acquired from the medium sensor 110 (the image greatly changes when the leading and trailing edges of the paper pass through the medium sensor 110).

Next, the image controller 202 executes print processing on the front side of the paper such that the top margin of the front side of the paper is constant (for example, the top margin is always “C mm”). In one aspect, in a case where the image is printed on the front side of the paper, the image controller 202 may always use a correction value generated on the basis of the reference length “X mm”, which is a length of a first sheet of the paper (for example, test print sheet) in the paper pass direction.

Next, the image controller 202 executes print processing on the back side of the paper such that the bottom margin of the back side of the paper is constant (for example, the bottom margin is always “C mm”) on the basis of the correction value acquired from the image analyzer 201. That is, the image controller 202 adjusts the top margin of the back side of the paper.

As described above, in a case where the print processing is executed on short paper, before the print processing, the image formation system 100 may sense a change in the length of the paper in the paper pass direction from the image acquired from the medium sensor 110, and, on the basis of the change in the length of the paper in the paper pass direction, may correct the image to be printed on the paper.

Next, the second operation procedure will be described. When a sheet of long paper is sensed, the image formation system 100 executes the second operation procedure. Here, the long paper means paper of which a leading edge thereof comes into contact with the registration roller 206 from when the leading edge of the paper passes through the medium sensor 110 to when a trailing edge thereof passes through the medium sensor 110. In other words, the long paper is paper of which length in the paper pass direction is equal to or longer than the conveyance path between the medium sensor 110 and the registration roller 206.

In a case where long paper is conveyed from the paper feed tray 130, the image analyzer 201 measures time from a timing when the conveyance is started again after the leading edge of the paper comes in contact with the registration roller 206 and temporarily stops, to when the trailing edge of the paper passes through the medium sensor 110. By measuring time from a timing when the conveyance is started again after the leading edge of the paper comes in contact with the registration roller 206 and temporarily stops, to when the trailing edge of the paper passes through the medium sensor 110, the image analyzer 201 may, without measuring an accurate shape (length in the paper pass direction) of the paper, detect how much a shape (length in the paper pass direction) of current paper has changed from the shape (length in the paper pass direction) of previously printed paper. The image analyzer 201 generates a correction value on the basis of a change in the current paper shape (length in the paper pass direction) from the shape (length in the paper pass direction) of the previously printed paper, and outputs the correction value to the image controller 202.

Next, the image controller 202 executes print processing on the front side of the paper such that the top margin of the front side of the paper is constant (for example, the top margin is always “C mm”). In one aspect, in a case where the image is printed on the front side of the paper, the image controller 202 may always use a correction value generated on the basis of the reference length “X mm”, which is a length of a first sheet of the paper (for example, test print sheet) in the paper pass direction.

Next, the image controller 202 executes print processing on the back side of the paper such that the bottom margin of the front side of the paper is constant (for example, the bottom margin is always “C mm”) on the basis of the correction value acquired from the image analyzer 201. That is, the image controller 202 adjusts the top margin of the back side of the paper.

As described above, in a case where the print processing is executed on long paper, before the print processing, the image formation system 100 may sense a change in the length of the paper in the paper pass direction from the image acquired from the medium sensor 110 after the paper comes in contact with the registration roller 206, and, on the basis of the change in the length of the paper in the paper pass direction, may correct the image to be printed on the paper.

The image formation system 100 does not need to measure an absolute value of the length of the paper in the paper pass direction in either case of detecting short paper or long paper, and is only required to obtain an amount of change in the shape of the current paper from a shape of the paper used in previous printing (or reference paper used in a test print). Because the image formation system 100 detects a change in shape (length in the paper pass direction) of the paper before the print processing, the image formation system 100 may immediately correct the image to be printed on the paper even in a case where the shape (length in the paper pass direction) of the paper has changed rapidly.

In addition, the image formation system 100 may perform printing such that the top margin of the front side of the paper is always kept constant, and may adjust only the top margin of the back side of the paper (match a length of the bottom margin of the back side of the paper with a length of the top margin of the back side of the paper). In this way, even in a case where the time from when the medium sensor 110 measures the shape (length in the paper pass direction) of the paper to when the front side of the paper reaches a transfer position is short (even in a case where there is no time to correct an image on the front side of the paper), the image formation system 100 can always match the position of the image on the front side of the paper with the position of an image on the back side.

In one aspect, the image formation system 100 may correct the position of the image to be printed on the front side of the paper every time, in a case where a sufficient time or distance is secured from when the medium sensor 110 measures the shape (length in the paper pass direction) of the paper to when the front side of the paper reaches the transfer position. The case where a sufficient time or distance is secured from when the medium sensor 110 measures the shape (length in the paper pass direction) of the paper to when the front side of the paper reaches the transfer position means a case in which the image controller 202 can complete a print setting including the correction value by a time when the front side of the paper reaches the transfer position after the medium sensor 110 has measured the shape (length in the paper pass direction) of the paper.

### C. Procedure for Processing Image Formation System

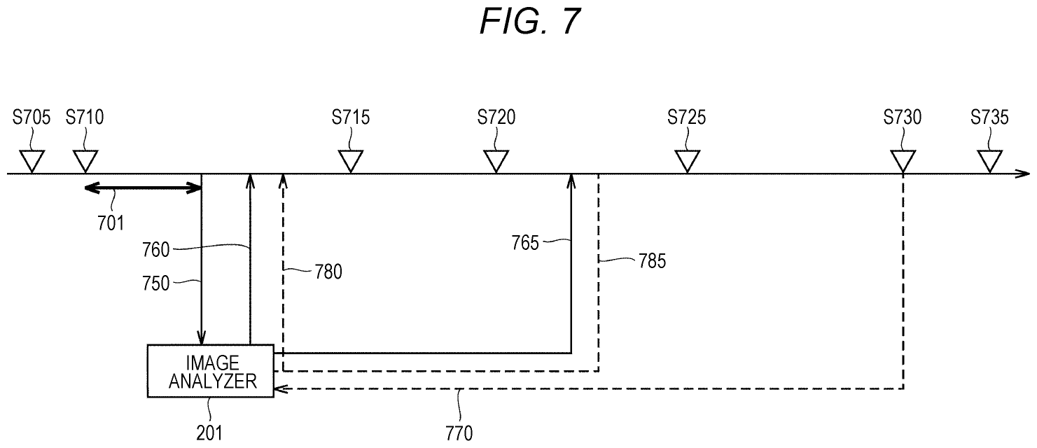

Next, internal processing of the image formation system 100 will be described with reference to FIGS. 7 to 9. FIG. 7 is a diagram showing an example of timing of each processing in the image formation system 100.

In step S705, the image controller 202 starts print operation and starts conveyance of the paper from the paper feed tray 130.

In step S710, the first medium sensing unit 101 detects the paper. A period 701 is a period during which the paper passes through the first medium sensing unit 101 (medium sensor 110). The image analyzer 201 generates a correction value for the image on the basis of an image 750 acquired from the first medium sensing unit 101. The correction value for the image may include both or one of a correction value for the image to be printed on the front side of the paper and a correction value for the image to be printed on the back side of the paper.

In a case where a sufficient time or distance is secured from when the medium sensor 110 measures the shape (length in the paper pass direction) of the paper to when the front side of the paper reaches the transfer position, the image analyzer 201 outputs a correction value 760 for the image to be printed on the front side of the paper to the image controller 202. Otherwise, the image controller 202 may print the image on the front side of the paper by always using the same correction value (for example, setting of the top margin “C mm” shown in FIG. 4, or the like). The image controller 202 generates a print setting by using the acquired correction value 760, and outputs the print setting to the image formation controller 205.

In step S715, the image transferer 102 transfers the toner image onto the front side of the paper. The transfer position of the toner image may be corrected on the basis of the correction value 760. For example, the position of the image may be corrected so that the top margin of the front side of the paper is always “C mm”. The fixer 103 fixes the toner image on the front side of the paper.

In step S720, the paper reverser 106 reverses the paper and returns the reversed paper to the conveyance path that is upstream of the registration roller 206. The image analyzer 201 outputs a correction value 765 for the image to be printed on the back side of the paper to the image controller 202. The image controller 202 generates a print setting by using the acquired correction value 765, and outputs the print setting to the image formation controller 205. In one aspect, the image analyzer 201 may output the correction value 765 for the image to be printed on the back side of the paper to the image controller 202 at a timing before step S715.

In step S725, the image transferer 102 transfers the toner image onto the back side of the paper. The transfer position of the toner image may be corrected on the basis of the correction value 765. For example, the position of the image may be corrected so that the bottom margin of the back side of the paper is always “C mm”. The fixer 103 fixes the toner image on the back side of the paper.

In step S730, the second medium sensing unit 105 outputs an image 770 on the printed paper to the image analyzer 201. On the basis of the image 770 acquired from the second medium sensing unit 105, the image analyzer 201 may further output correction values 780 and 785 obtained by further adjusting the correction values 760 and 765 to the image controller 202. For example, the paper may be deformed by heat and moisture inside the image formation apparatus 200. Therefore, the image analyzer 201 may sense a deviation in a print result of the image acquired from the second medium sensing unit 105, and may generate the correction values 780 and 785 obtained by further adjusting the correction values 760 and 765 on the basis of the sensed deviation.

In step S735, the relay unit 104 and the like eject the printed paper.

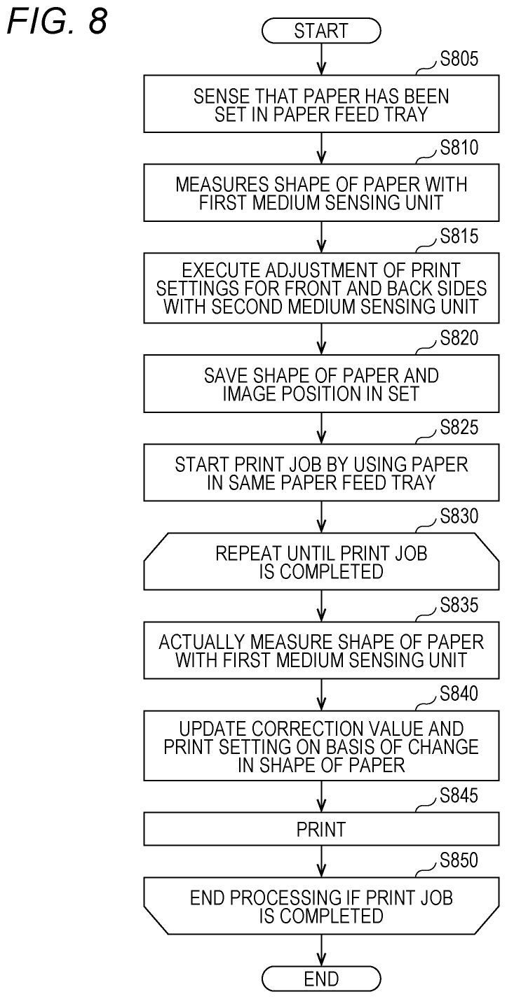

FIG. 8 is a flowchart showing the first example of internal processing in the image formation system 100. The flowchart shown in FIG. 8 shows processing of executing image correction without using the second medium sensing unit 105 when executing printing. In one aspect, the image analyzer 201 or the image controller 202 may read a program for performing the processing in FIG. 8 from a non-volatile storage medium (not shown) into a main storage (not shown), and may execute the program. In another aspect, a part or all of the processing may be implemented as a combination of circuit elements formed to execute the processing.

In step S805, the image formation system 100 senses that the paper has been set in the paper feed tray 130. The image formation system 100 may sense input operation for a test print of the paper. The test print here is printing for determining a length of a margin with the length of the test-printed paper in the paper pass direction as the reference length (corresponding to the processing described with reference to FIGS. 3 and 4).

In step S810, with the first medium sensing unit 101, the image formation system 100 actually measures the shape (length in the paper pass direction) of the paper. In one aspect, in a case where long paper is conveyed from the paper feed tray 130, the image formation system 100 may measure time from a timing when the conveyance is started again after the leading edge of the paper comes in contact with the registration roller 206 and temporarily stops, to when the trailing edge of the paper passes through the medium sensor 110.

In step S815, with the second medium sensing unit 105, the image formation system 100 acquires an image on the printed paper, and executes adjustment of print settings for the front and back sides. More specifically, the image formation system 100 may adjust a subtle deviation, distortion, or the like between the position of the image on the front side of the paper and the position of the image on the back side of the paper that are in an actual print result.

In step S820, the image formation system 100 saves, in the main storage or the non-volatile storage medium, the shape of the paper and the image position (for example, the length “X mm” in the paper pass direction and the margin “C mm”) in a set. With the processing in steps S805 to S820, the image formation system 100 may determine an initial print setting (for example, the length in the paper pass direction is determined to be “X mm”, and a margin is determined to be “C mm”).

In step S825, the image formation system 100 starts a print job by using the paper in the same paper feed tray 130.

In step S830, the image formation system 100 repeatedly executes the processing in step S835 and subsequent steps until the print job is completed.

In step S835, with the first medium sensing unit 101, the image formation system 100 actually measures the shape (amount of the change in the length in the paper pass direction) of the paper. In one aspect, in a case where long paper is conveyed from the paper feed tray 130, the image formation system 100 may measure time from a timing when the conveyance is started again after the leading edge of the paper comes in contact with the registration roller 206 and temporarily stops, to when the trailing edge of the paper passes through the medium sensor 110. The image formation system 100 does not need to measure an absolute value of the length of the paper in the paper pass direction, and is only required to obtain an amount of the change in the shape of the current paper with respect to a shape of the paper used in previous printing (or reference paper used in a test print).

In step S840, the image formation system 100 updates the correction value and the print setting on the basis of the shape (length in the paper pass direction) of the paper.

In step S845, the image formation system 100 executes printing on the basis of the updated correction value and print setting. In one aspect, the image formation system 100 may correct the position of the image to be printed on the front side of the paper every time, in a case where a sufficient time or distance is secured from when the medium sensor 110 measures the shape (length in the paper pass direction) of the paper to when the front side of the paper reaches the transfer position. In another aspect, the image formation system 100 may perform printing such that the top margin of the front side of the paper is always kept constant, and may adjust only the top margin of the back side of the paper.

In step S850, if the print job is completed, the image formation system 100 ends the processing. Otherwise, the image formation system 100 repeatedly executes the processing in step S835 and subsequent steps. In one aspect, at the timing in step S830, the image formation system 100 may judge whether or not the print job is completed.

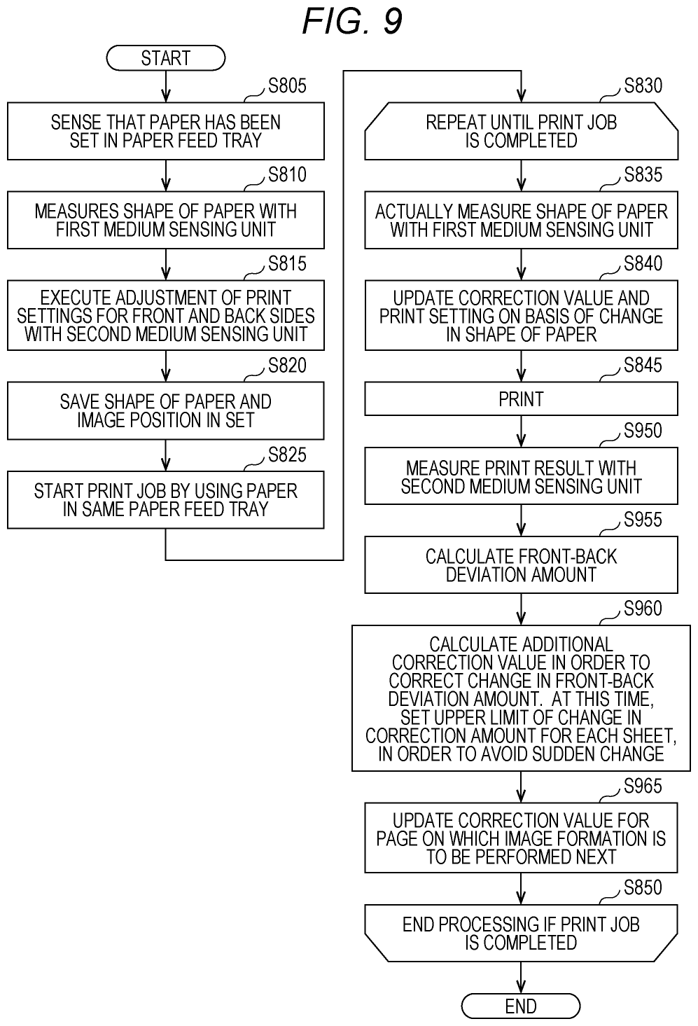

FIG. 9 is a flowchart showing a second example of internal processing in the image formation system 100. The flowchart shown in FIG. 9 shows processing of executing image correction by using the second medium sensing unit 105 when executing printing. In one aspect, the image analyzer 201 or the image controller 202 may read the program for performing the processing in FIG. 9 from the non-volatile storage medium into the main storage, and may execute the program. In another aspect, a part or all of the processing may be implemented as a combination of circuit elements formed to execute the processing. Among processing shown in FIG. 9, the same processing as the processing in FIG. 8 is denoted by the same step number. Therefore, description of the same processing will not be repeated.

In step S950, the image formation system 100 measures a print result with the second medium sensing unit 105. In one aspect, the image formation system 100 may analyze the image (paper detection data) acquired from the second medium sensing unit 105, and may judge whether or not image position deviation has occurred due to a change in the shape of the paper or the image position deviation has occurred due to an environmental change.

In a case where the image position deviation has occurred due to a change in the shape of the paper, the image formation system 100 may eject the paper as waste paper and correct the image position deviation on the basis of the change in the shape of the paper. In a case where the image position deviation has occurred due to an environmental change, the image formation system 100 may correct the print position of the image by using the image acquired from the second medium sensing unit 105.

In step S955, the image formation system 100 calculates a front-back deviation amount (amount of deviation between the position of the image on the front side of the paper and the position of the image on the back side of the paper in the print result) of the image.

In step S960, the image formation system 100 calculates an additional correction value in order to correct the change in the front-back deviation amount. At this time, the image formation system 100 sets an upper limit of the change in the correction amount for each sheet to be printed, in order to avoid a sudden change.

In step S965, the image formation system 100 updates a correction value for a page on which image formation is to be performed next. More specifically, the image formation system 100 may update the final correction value and the print setting on the basis of the additional correction value obtained in step S960 and the shape (length in the paper pass direction) of the paper obtained in steps S835 and S840 in a next loop.

### D. Application Examples

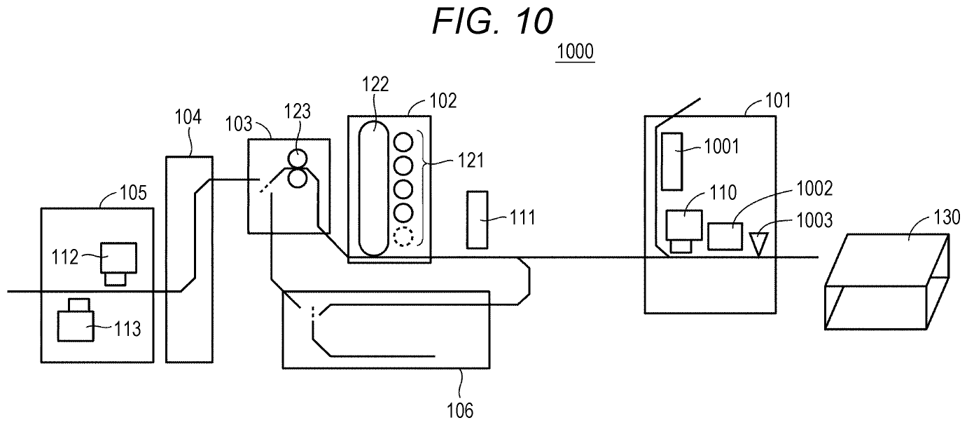

Next, application examples of the image formation system 100 will be described with reference to FIGS. 10 to 14. In one aspect, contents disclosed in FIGS. 1 to 14 may be used in combination as appropriate.

FIG. 10 is a diagram showing a second example of a hardware configuration of an image formation system according to the present embodiment. An image formation system 1000 further includes sensors 1001, 1002, and 1003 in addition to the configuration of the image formation system 100.

The sensors 1001 and 1002 are sensors for detecting a type or attribute of the paper. In one aspect, the sensors 1001, 1002 may be a paper thickness sensor or a basis weight sensor. The paper thickness sensor and the basis weight sensor may measure thickness or weight of the paper. As an example, the sensors 1001, 1002 may be contact sensors or non-contact sensors that directly measure thickness, or may measure the shape of the front side of the paper, glossiness of the paper, rigidity of the paper, strength against bending of the paper, an amount of light transmitted through the paper, or the like. The image analyzer 201 may estimate the thickness of the paper on the basis of these pieces of information.

Behavior when the paper is conveyed by a conveyance roller may change depending on the hardness and thickness of the paper. For example, in a case where the paper has obliquely come in contact with the conveyance roller, a change occurs in how the paper is bent, how the paper is bitten by a next conveyance roller, or the like, which may affect an image drawing position. Therefore, the image analyzer 201 may predict, from the change in the shape of the paper, a change in the position of the image to be printed, and may adjust, on the paper on the basis of the prediction, the correction value for the image to be printed.

For paper having a representative paper characteristic, the image analyzer 201 may use a prediction formula for predicting, from a change in shape of each sheet of the paper, a change in the image position. The image analyzer 201 may select representative paper close to a paper property measured by the paper thickness sensor and the basis weight sensor, and may correct the front-back deviation by using the prediction formula for the selected representative paper.

In another aspect, the sensors 1001, 1002 may be a glossiness sensor or a smoothness sensor. The glossiness sensor and the smoothness sensor measure glossiness and smoothness of the front side of the paper. Difference in glossiness or smoothness of the front side of the paper affects, for example, slippage when the paper is conveyed by the conveyance roller.

In still another aspect, the sensors 1001, 1002 may be moisture content sensors. A characteristic of the paper greatly changes depending on moisture content of the paper. For example, if the paper is dry, some change occurs. For example, paper shrinkage due to the fixing is reduced, an amount of electric charge during paper conveyance is increased, and the paper is easily attracted to the conveyance roller. The moisture content can be determined, for example, by measuring conductivity of the paper.

On the basis of information of a type or attribute of the paper, the information being obtained from the sensors 1001 and 1002, the image analyzer 201 may further adjust the correction value for the image to be printed on the paper. In one aspect, the image analyzer 201 may receive input of attribute information from the operation display 204. The image analyzer 201 may estimate, on the basis of the attribute information, a change in size due to the fixing processing on the paper, and may adjust the correction amount of the print position of the image on the basis of the estimated size change. In another aspect, in order not to change the image position rapidly, the image analyzer 201 may reduce the correction amount of the print position of the image, in response to judgment, which is based on the attribute information, that the size change of the paper due to the fixing processing is equal to or greater than a predetermined amount.

The sensor 1003 is a paper pass sensor, and may be used for judgment of abnormality in paper. It is assumed that the length of the current paper is longer by 1% than the length of the previous paper. In this case, it is predicted that time required for the current paper to pass through each of the image sensors or the paper pass sensor will also be longer by 1%. In a case where the amount of change in time of the paper passing does not match between the sensors, it is considered that some change has occurred to the paper when the paper is passing through the conveyance path. For example, in a case where time when the paper passes through the sensor 1003 (or an amount of change in the time) does not match time when the paper passes through the medium sensor 110 (or an amount of change in the time), there is a possibility that some change has occurred to the paper and, therefore, a change in the length of the paper in the paper pass direction has failed to be properly measured. In this case, the image formation system 100 may eject the paper as waste paper to an abnormal paper ejection path and execute the print processing again. In addition, the image formation system 100 may display, on the operation display 204, a message for notifying the user of the occurrence of the abnormality, or may transmit the message to a computer of the user. Note that a position of the sensor 1003 used here is not limited to the position shown in the drawing. For example, in a case where a plurality of paper trays is connected in series to a printer main body, a sensor can be disposed at a position farther away from the main body, and in a case where printing is performed on a longer sheet of paper, the sensor may function effectively.

Note that the sensors 1001, 1002, and 1003 shown in FIG. 10 are merely examples, and a type, the number, and arrangement of the sensors 1001, 1002, and 1003 may be arbitrarily determined.

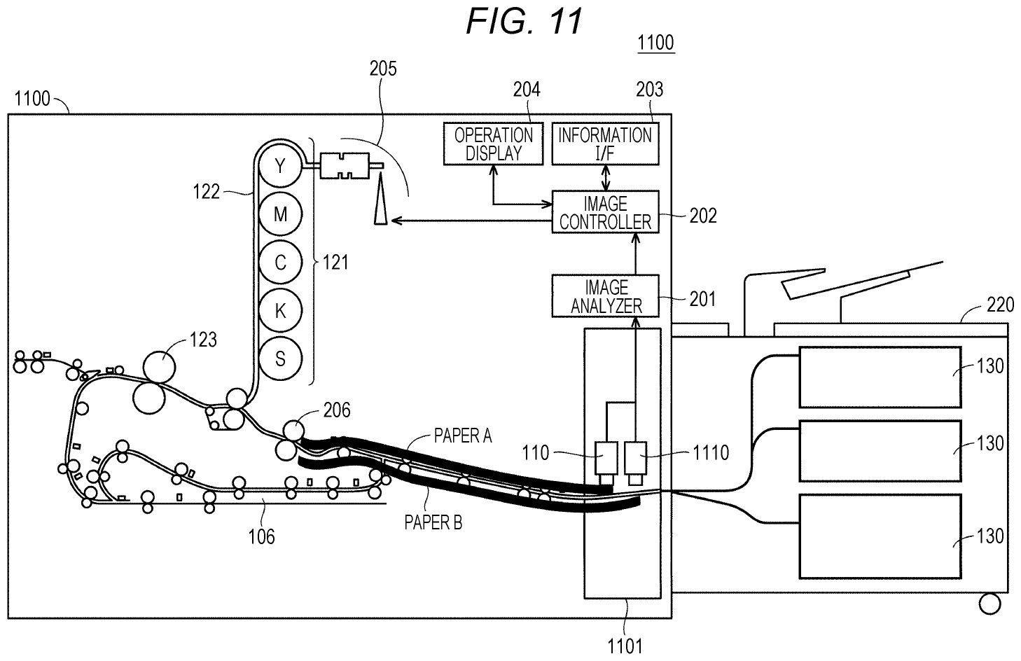

FIG. 11 is a diagram showing a third example of a hardware configuration of the image formation system according to the present embodiment. An image formation system 1000 further includes a medium sensor 1110 in addition to the configuration of the image formation system 100.

It is assumed that length of paper A to be printed next is length of whether or not the trailing edge of the paper passes through the medium sensor 110 in a state where a leading edge of the paper A is in contact with the registration roller 206 and is temporarily stopped. Before and after the paper A comes into contact with the registration roller 206 and temporarily stops, a rapid change occurs in speed of paper conveyance or the path of the paper. Therefore, there is a possibility that the image analyzer 201 cannot stably measure the change in the length of the paper A only with the medium sensor 110. Therefore, an image formation system 1100 includes, for example, the medium sensor 1110 slightly upstream of the medium sensor 110. The paper A completely passes through the medium sensor 1110 before the leading edge of the paper A comes into contact with the registration roller 206. Therefore, the medium sensor 1110 can stably measure the change in the length of the paper A in the paper pass direction (first operation procedure).

Furthermore, it is assumed that length of paper B to be printed next is length of whether or not the trailing edge of the paper passes through the medium sensor 1110 in a state where a leading edge of the paper B is in contact with the registration roller 206 and is temporarily stopped. In this case, the paper B has not passed through the medium sensor 110 yet when the leading edge of the paper B comes into contact with the registration roller 206 and stops. Therefore, the medium sensor 110 can stably measure the change in the length of the paper B in the paper pass direction (second operation procedure).

As described above, by including two medium sensors 110 and 1100, the image formation system 1000 may measure a change in the length of the paper of any shape, including non-uniform paper, in the paper pass direction.

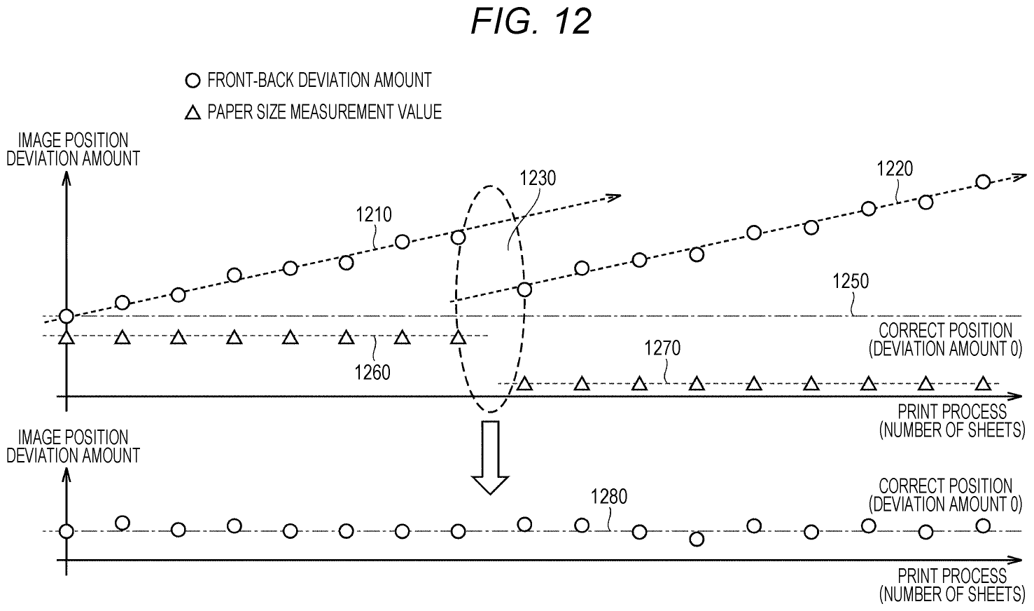

FIG. 12 is a diagram showing an example of a result of correcting an image position deviation amount when the processing shown in the flowchart in FIG. 9 is executed. The image position deviation amount may include, for example, an amount of bias of the image from a center of the paper, a deviation amount between the image position on the front side of the paper and the image position on the back side of the paper, and the like.

Graphs 1210 and 1220 illustrate changes in magnitude of the image position deviation amount of the image to be printed on the paper when the image formation system 100 does not execute image correction. Graphs 1260 and 1270 illustrate results of measuring the amount of change in the shape of the paper. A graph 1250 indicates a correct position (correct correction amount).

According to the graphs 1210 and 1220, in a case where the image formation system 100 does not execute image correction, the image position deviation amount gradually increases. In addition, the image position deviation amount greatly changes at timing 1230. Thus, it is inferred that the shape of the paper placed in the paper feed tray 130 has changed at the timing 1230.

By using the measurement result acquired from the second medium sensing unit 105, each image formation system according to the present embodiment may correct the image position deviation amount of the paper and may reduce a gradual increase in the image position deviation amount due to environmental change or the like, as shown by the graphs 1210 and 1220. In addition, by using the measurement result acquired from the first medium sensing unit 101, each image formation system according to the present embodiment may reduce a rapid increase in the image position deviation amount due to a change in the shape of the paper, or the like, as shown by the timing 1230. A graph 1280 shows a change in the image position deviation amount in a case where each image formation system according to the present embodiment uses results of measurement by the first medium sensing unit 101 and the second medium sensing unit 105 to correct the image. The graph 1280 may take a value close to the graph 1250 that shows the correct position.

FIG. 13 is a diagram showing a first application example of image correction by the image formation system according to the present embodiment. The image formation system (image formation systems 100, 1000, and 1100) further includes a paper bias sensor 1300. For example, the paper bias sensor 1300 may be provided upstream of the registration roller 206 in the conveyance path.

First, the image analyzer 201 detects a distance 1320A from the paper bias sensor 1300 to a front side 1310A of the paper on the basis of a signal from the paper bias sensor 1300.

Next, the image analyzer 201 detects a distance 1320B from the paper bias sensor 1300 to a back side 1310B of the paper on the basis of a signal from the paper bias sensor 1300.

Next, on the basis of a difference between the distance 1320A and the distance 1320B, the image analyzer 201 calculates a deviation amount between a position of an image 1330A to be printed on the front side 1310A of the paper and a position of an image 1330B to be printed on the back side 1310B of the paper.

Finally, the image analyzer 201 calculates the image correction amount on the basis of the deviation amount, and outputs the correction amount to the image controller 202. Next, on the basis of the correction amount, the image controller 202 matches the position of the image 1330A to be printed on the front side 1310A of the paper and the position of the image 1330B to be printed on the back side 1310B of the paper.

In one aspect, on the basis of the correction amount, the image controller 202 may match the position of the image 1330B to be printed on the back side 1310B of the paper with the position of the image 1330A to be printed on the front side 1310A of the paper. In another aspect, on the basis of the correction amount, the image controller 202 may also correct the position of the image 1330A to be printed on the front side 1310A of the paper, in a case where a sufficient time or distance is secured during a period from when the medium sensor 110 measures the shape (length in the paper pass direction) of the paper to when the front side of the paper reaches the transfer position. In another aspect, the image controller 202 may detect paper bias or the like by using the medium sensor 110 instead of the paper bias sensor 1300, or may detect paper bias or the like by using both the medium sensor 110 and the paper bias sensor 1300.

As described above, the image formation system may also correct the image position deviation with respect to a direction perpendicular to the paper pass direction by detecting paper bias or the like.

FIG. 14 is a diagram showing the second application example of image correction by the image formation system according to the present embodiment. The image analyzer 201 may sense a change in the shape of the paper (distortion such as a change from a rectangle to a trapezoid) by using the medium sensor 110 or the paper bias sensor 1300, or both.

In a case where a change in the shape of the paper (angle of the paper, shape or distortion of an edge, or the like) is sensed, the image analyzer 201 may generate the correction value so as to change the shape of the image in accordance with the change in the shape of the paper, and may output the correction value to the image controller 202.

In one aspect, the image analyzer 201 may generate the correction value so as to change the shape of the image in accordance with the shape of the edge of the paper in the paper pass direction. In another aspect, the image analyzer 201 may generate the correction value so as to change the shape of the image in accordance with the shape of the edge of the paper in a direction opposite to the paper pass direction. In another aspect, the image analyzer 201 may generate the correction value so as to change the shape of the image in accordance with an arbitrary shape of the edge of the paper. Furthermore, in another aspect, the image analyzer 201 may generate the correction value so that the image to be printed on the front side of the paper and the image to be printed on the back side of the paper overlap.

Note that the image formation system may detect all or part of the change in the length of the paper in the paper pass direction, the change of the distortion of the paper, and the change in the edge of the paper, and may generate the correction value for the image in accordance with these changes.

In one aspect, in a case where the image position deviation has occurred due to the change in the length of the paper, the image analyzer 201 may correct the print position of the image on the basis of a timing of operation of the registration roller 206 or a timing of transfer of the image. In another aspect, in a case where the image position deviation has occurred due to the angle of the paper, or shape or distortion of the edge, the image analyzer 201 may deform the image to be printed on the paper (may correct the shape of the image).

As described above, on the basis of the change in the shape of the paper, the image formation system according to the present embodiment may correct the image to be printed on the paper. As a result, the image formation system may appropriately adjust the print position of the image even in a case where the shape of the paper changes rapidly during printing.

Although embodiments of the present invention have been described and illustrated in detail, the disclosed embodiments are made for purposes of illustration and example only and not limitation. The scope of the present invention should be interpreted by terms of the appended claims. The scope of the present disclosure is intended to include meanings equivalent to the scope of the claims and all modifications within the scope. The disclosed contents described in the embodiment and modifications are intended to be implemented each alone or in combination wherever possible.

What is claimed is:

1. An image formation apparatus comprising:
an image former that prints an image on paper;
a corrector that corrects a print position of the image on the paper; and
a first sensor that is disposed on a conveyance path upstream of the image former, detects paper, and outputs detection data to the corrector,
wherein the corrector obtains, on the basis of the detection data, an amount of change in a shape of first paper from a shape of second paper printed before the first paper is printed, and
corrects a print position of a first image on the first paper on the basis of the change amount.

2. The image formation apparatus according to claim 1,
wherein correcting, on the basis of the change amount, the position of the first image formed on the first paper includes unification of a size of a margin of a second image formed on the second paper and a size of a margin of the first image, the margins being in a first direction.

3. The image formation apparatus according to claim 2,
wherein the margin in the first direction is margins of the first paper and second paper in a paper pass direction on the conveyance path, or is a margin opposite to the paper pass direction.

4. The image formation apparatus according to claim 2,
wherein, on the basis of performing two-sided printing on the first paper, the corrector corrects a print position of an image on a back side of the first paper so that the image on the back side of the first paper overlaps an image on a front side of the first paper.

5. The image formation apparatus according to claim 1, the image formation apparatus further comprising a registration roller disposed on the conveyance path and between the image former and the first sensor,
wherein the corrector switches operation of obtaining the change amount, on the basis of whether or not a leading edge of the paper comes into contact with the registration roller before a trailing edge of the paper completely passes through the first sensor.

6. The image formation apparatus according to claim 5,
wherein, in a case where the leading edge of the paper does not come into contact with the registration roller before the trailing edge of the paper completely passes through the first sensor, the corrector obtains the change amount on the basis of time from when the first sensor senses the leading edge of the paper to when the trailing edge of the paper passes through the first sensor.

7. The image formation apparatus according to claim 5,
wherein, in a case where the leading edge of the paper comes into contact with the registration roller before the trailing edge of the paper completely passes through the first sensor, the corrector obtains the change amount on the basis of time from when the paper moves again after coming into contact with the registration roller and temporarily stopping, to when the trailing edge of the paper passes through the first sensor.

8. The image formation apparatus according to claim 1, the image formation apparatus further comprising a second sensor that detects the paper at a position different from the first sensor on the conveyance path,
wherein, on the basis that the change amount detected by the first sensor and the change amount detected by the second sensor are different, the corrector ejects the first paper as waste paper and executes print processing again.

9. The image formation apparatus according to claim 1, the image formation apparatus further comprising, downstream of the image former on the conveyance path, a third sensor that detects the paper having been subjected to print processing,
wherein the corrector analyzes detection data of the paper having been subjected to print processing, the detection data being acquired from the third sensor,
ejects the paper as waste paper and corrects the image position deviation on the basis of the change in the shape of the paper in a case where the image position deviation has occurred due to the change in the shape of the paper, and
corrects the print position of the image by using a result of measurement by the third sensor in a case where the image position deviation has occurred due to an environmental change.

10. The image formation apparatus according to claim 1, the image formation apparatus further comprising an inputter for receiving input of attribute information of the paper or a fourth sensor that acquires the attribute information,
wherein the corrector
acquires the attribute information from the inputter or from the fourth sensor, and
estimates a size change of the paper due to fixing processing on the basis of the attribute information, and adjusts a correction amount of the print position of the image on the basis of the estimated size change.

11. The image formation apparatus according to claim 10,
wherein the corrector reduces the correction amount of the print position of the image in response to judgment, based on the attribute information, that the size change of the paper due to the fixing processing is equal to or greater than a predetermined amount.

12. The image formation apparatus according to claim 5,
wherein,
in a case where the image position deviation has occurred due to the change amount, the corrector corrects, on the basis of a timing of operation of the registration roller or a timing of transfer of the image, the print position of the image to be printed on the first paper, and
in a case where the image position deviation has occurred due to an angle of the first paper, or a shape or distortion of an edge, the corrector deforms the image to be printed on the first paper.

13. A method for controlling an image formation apparatus, the control method comprising:
acquiring paper detection data from a first sensor disposed on a conveyance path upstream of an image former;
obtaining, on the basis of the detection data, an amount of change in a shape of first paper from a shape of second paper printed before the first paper is printed; and
correcting a print position of a first image on the first paper on the basis of the change amount.

14. The control method according to claim 13,
wherein correcting, on the basis of the change amount, the position of the first image formed on the first paper includes unification of a size of a margin of a second image formed on the second paper in a first direction, and a size of a margin of the first image, the margins being in a first direction.

15. The control method according to claim 14,
wherein the margin in the first direction is margins of the first paper and second paper in a paper pass direction on the conveyance path, or is a margin opposite to the paper pass direction.

16. The control method according to claim 14, the control method further comprising, on the basis of performing two-sided printing on the first paper, correcting a print position of an image on a back side of the first paper so that the image on the back side of the first paper overlaps an image on a front side of the first paper.

17. The control method according to claim 13, the control method further comprising switching operation of obtaining the change amount, on the basis of whether or not a leading edge of the paper comes into contact with a registration roller disposed on the conveyance path and between the image former and the first sensor, before a trailing edge of the paper completely passes through the first sensor.

18. The control method according to claim 17, the control method further comprising, in a case where the leading edge of the paper does not come into contact with the registration roller before the trailing edge of the paper completely passes through the first sensor, obtaining the change amount on the basis of time from when the first sensor senses the leading edge of the paper to when the trailing edge of the paper passes through the first sensor.

19. The control method according to claim 17, the control method further comprising, in a case where the leading edge of the paper comes into contact with the registration roller before the trailing edge of the paper completely passes through the first sensor, obtaining the change amount on the basis of time from when the paper moves again after coming into contact with the registration roller and temporarily stopping, to when the trailing edge of the paper passes through the first sensor.

20. The control method according to claim 13, the control method further comprising, on the basis that the change amount detected by the first sensor and the change amount detected by a second sensor that detects the paper at a position different from the first sensor on the conveyance path are different, ejecting the first paper as waste paper and executing print processing again.

21. The control method according to claim 13, the control method further comprising:
analyzing detection data of the paper having been subjected to print processing, the detection data being acquired from a third sensor that detects, downstream of the image former on the conveyance path, the paper having been subjected to print processing;
ejecting the paper as waste paper and correcting the image position deviation on the basis of the change in the shape of the paper in a case where the image position deviation has occurred due to the change in the shape of the paper, and
correcting the print position of the image by using a result of measurement by the third sensor in a case where the image position deviation has occurred due to an environmental change.

22. The control method according to claim 13, the control method further comprising:
acquiring, from an inputter for receiving input of attribute information of the paper or from a fourth sensor that acquires the attribute information, the attribute information; and
estimating a size change of the paper due to fixing processing on the basis of the attribute information, and adjusting a correction amount of the print position of the image on the basis of the estimated size change.

23. The control method according to claim 22, the control method further comprising reducing the correction amount of the print position of the image in response to judgment, based on the attribute information, that the size change of the paper due to the fixing processing is equal to or greater than a predetermined amount.

24. The control method according to claim 17, the control method further comprising:
in a case where the image position deviation has occurred due to the change amount, correcting, on the basis of a timing of operation of the registration roller or a timing of transfer of the image, the print position of the image to be printed on the first paper; and
in a case where the image position deviation has occurred due to an angle of the first paper, or a shape or distortion of an edge, deforming the image to be printed on the first paper.
